(19) United States
(12) Patent Application Publication
(10) Pub. No.: US 2011/0015797 A1
(43) Pub. Date: Jan. 20, 2011

(54) METHOD AND APPARATUS FOR HOME AUTOMATION AND ENERGY CONSERVATION

(76) Inventor: Daniel Gilstrap, Midvale, UT (US)

Correspondence Address: MORRISS OBRYANT COMPAGNI, P.C., 734 EAST 200 SOUTH, SALT LAKE CITY, UT, 84102, US

(21) Appl. No.: 12/502,916

(22) Filed: Jul. 14, 2009

(51) Int. Cl. G06F 1/32; G06Q 99/00

(52) U.S. Cl. 700/291; 700/296; 700/295; 705/1.1

(57) ABSTRACT

A system for reducing utility consumption of at least one subsystem of a facility is disclosed. A utility meter is coupled to the subsystem for monitoring utility consumption of the subsystem and provides data corresponding to the measured energy consumption. A controller in communication with the subsystem and the energy meter is configured to control the operation of the subsystem by employing an operating protocol with the protocol dependent on the data received from the utility meter. The system measures the reduction in utility consumption and generates a credit based on the measured reduction.

### CROSS-REFERENCE TO RELATED APPLICATION

The present application claims priority to U.S. Provisional Patent Application 60/080,596 filed on Jul. 14, 2008 to Daniel Gilstrap, the entirety of which is incorporated by this reference.

### FIELD OF THE INVENTION

The present invention relates generally to systems for home automation, and more specifically, to a system for automating the lighting, climate controls and other devices to decrease energy consumption and increase the home's energy efficiency.

### BACKGROUND OF THE INVENTION

Various levels of home automation have been available for decades. Such home automation systems have been provided to control lighting, climate control and other household systems. Such systems are typically programmed to operate based upon the desires of the homeowner, such as when to turn lights on and off and the temperature of the living spaces. These systems typically require expensive components that cost tens of thousands of dollars and controllers that require specialized complex programming, thus making them unaffordable and not accessible to the average home owner. Such systems also fail to provide intelligent monitoring and control in a self learning manner that is affordable, easy to install and that utilizes preexisting components that allow remote access and control of the home automation system.

One wireless communication protocol for home automation and sensor networks that has been developed using radio frequency (“RF”) signals is known as Z-Wave. Z-Wave is the interoperable wireless communication protocol developed by Danish company Zensys and the Z-Wave Alliance. It is designed for low-power and low-bandwidth appliances, such as home automation and sensor networks. Z-Wave is a widely used RF technology for remote control devices. Z-Wave technology with low power consumption, 2-way RF, mesh networking technology and battery-to-battery support is well suited for sensors and control units. Z-Wave mesh networking technology routes 2-way command signals from one Z-Wave device to another around obstacles or radio dead spots that might occur.

Z-Wave-enabled devices have been designed for those interested in the following:

Controlling lighting remotely. This includes dimming of both incandescent and magnetic lighting.

Controlling blinds, drapes, or projection screens.

Controlling or monitor a thermostat from a distance.

Controlling “scenes”. A scene can set the level of several light switches at the same time. For example, a “Start a movie” scene might turn off the lights throughout the first floor except in the living room, dim those lights to 20%, and close the blinds in the living room.

Triggering scenes using external events such as the garage door opening, motion detected by a motion detector, or the time of day.

Z-Wave is, in a sense, a better X10 (industry standard). Where X10 sends signals over power lines and offers an optional RF adapter, Z-wave is completely RF based. Z-wave systems respond much more quickly than X10-based systems, and offer native acknowledgment to ensure that messages are not lost without generating an error. X10 systems took approximately one second to send a command. Z-wave systems can send a command and receive an acknowledgment in about 50 ms. Most nodes in a Z-Wave system are also repeaters. Thus, a controller does not need to be within the transmission range of the device it is trying to address if a series of hops will get the message there.

Also, Z-Wave has substantially better security than X10. Each controller has a 32 bit home code. When that controller is used to create a network, that home code is assigned into each device and controller as it is added to the network. Comparing this to X-10, which has 16 house codes (or 4 bits, versus 32 in Z-wave), Z-Wave devices hear message for other home codes, but will not relay or respond to them. A skilled attacker could potentially forge messages for a house code, but an accidental occurrence of this happening would be very rare.

A network of Z-Wave devices requires at least one controller and one controllable device. A controller cannot control a device until it is “added” to the network. Usually this amounts to pressing a key sequence on the controller and a button on the device to pair them. Every controller is different in terms of how it subsequently controls the device after that. Under current methods and equipment, the setup sequence is far from intuitive on most controllers and is perhaps the Achilles heel of the whole system in terms of usability. This process is repeated for each device in the system. Because the controller is learning the signal strength between the devices during this process, it is important that the devices themselves be in their final location before they are added to the system. Also, it's important to properly remove a node from the system using a “removal” process if a node is going to be removed. It is generally not recommended to simply unplug it or move its location.

Most users start with a portable controller to setup their network. Two such controllers currently on the market are the Intermatic HA07 and the Leviton RZCPG. The controller used to create the network is the primary controller. That controller can copy the node network to other controllers. Note that this process will unfortunately have to be repeated each time a new node is added. Using this process, someone can add multi-device remote controls such as some of Logitech's Harmony remotes or USB or serial interface controllers for their PC. Some software that can control multiple devices, including HomeSeer and ThinkEssentials, is available.

The computer controllers that interface to Z-wave systems speak a standardized serial protocol. As such, Z-wave devices interoperate very well. Consumers can buy a controller from brand A, a USB stick from brand B, and light switches from brand C and they will all work together. Z-wave devices operate at a bandwidth of 9,600 bit/s or 40 Kbit/s, fully interoperable. The modulation is GFSK and has a range of approximately 100 feet (or 30 meters) assuming “open air” conditions, with reduced range indoors depending on building materials, etc. The frequency band for Z-wave radio transmissions uses 900 MHz ISM band: 908.42 MHz (USA); 868.42 MHz (Europe); 919.82 MHz (Hong Kong); and 921.42 MHz (Australia/New Zealand). In Europe, the 868 MHz band has a 1% duty cycle limitation, meaning that a Z-wave unit can only transmit 1% of the time. This limitation is not present in the US 908 MHz band, but US legislation imposes a 1 mW transmission power limit (as opposed to 25 mW in Europe). Z-wave units can be in power-save mode and only be active 0.1% of the time, thus reducing power consumption dramatically.

Z-wave uses an intelligent “Mesh network” topology and has no master node. A message from node A to node C can be successfully delivered even if the two nodes are not within range providing that a third node B can communicate with nodes A and C. If the preferred route is unavailable, the message originator will attempt other routes until a path is found to the “C” node. Therefore a Z-wave network can span much further than the radio range of a single unit. In order for Z-wave units to be able to route unsolicited messages, they cannot be in sleep mode. Therefore, it is most often the case to net set up battery-operated devices as repeater units. A Z-wave network can consist of up to 232 units with the option of bridging networks if more units are required or desired.

As such, there exists a need in the art to provide a home automation system that incorporates preexisting devices, such as Z-wave devices, that is simple, reliable, easy to install and relatively inexpensive and that provides remote access to the controller of the home automation system to allow remote control of the system from any location away from the home.

### SUMMARY OF THE INVENTION

Accordingly, the present invention provides a home automation system and method of controlling a home automation system. The system and method reduces energy consumption of a home that reduces energy costs and decreases the carbon footprint that results from the decreased use of carbon-based energy sources, such as some electricity sources, natural gas, etc. The system employs peak load management over prescribed periods of time while controlling household systems in a user friendly manner. The system coordinates home owner desires of convenience and cost.

The system employs the use of “off-the-shelf” components to make the system easy to manufacture. Of course, custom and/or re-engineered components may be employed without departing from the spirit or scope of this present invention.

By using off-the-shelf components, however, the system can be produced relatively inexpensively for homeowners and/or builders, especially when compared to currently available home automation systems.

In one embodiment, the system uses an APPLE computer operating the APPLE OSX operating system. Because of the proven reliability of the APPLE OSX operating system, the system is not likely susceptible to computer viruses or unexpected system crashes that often plague other personal computer operating systems. As such, computer software according to the present invention is loaded onto an APPLE computer, such as a MAC MINI, running the APPLE OSX operating system. The MAC MINI operates as the system controller. Access to and control of the software can be achieved through an application software interface on the MAC MINI. It is also contemplated that other operating systems, such as LINUX or other standard or custom real time operating systems may be employed without departing from the spirit and scope of the present invention.

In another embodiment, access to and control of the software is achieved through an application software interface on an APPLE IPHONE or IPOD TOUCH. The IPHONE or IPOD TOUCH is configured to communicate with the system controller and includes preprogrammed graphical buttons and controls for remotely controlling the home automation system of the present invention. The IPHONE can communicate away from the home wherever the IPHONE has cellular telephone coverage. The controller can be configured to transmit to the IPHONE or IPOD TOUCH whenever a system parameter has been changed or is about to make a change. It is further anticipated that other compatible user interfaces may be employed in accordance with the present invention as other user interfaces are developed in the future. Thus, the use of an IPHONE or IPOD TOUCH is by way of example and not by limitation.

In yet another embodiment, access to and control of the software is achieved through an Internet accessible web page. The web page resides on the controller to allow the user to log into the controller and thus remotely control the home automation system of the present invention wherever an Internet terminal is available. The present invention anticipates use of hardware, software, and firmware as available resources on a network extending beyond the physical confines of a particular facility within which the automation system has been installed. Thus, the automation system includes a collection of hardware, software, and networking systems that work together from both within and external to the facility.

The automation system of the present invention is configured to collect and store data (whether local or remote) regarding the status and various operating parameters of the system. This data is then used for various purposes according to the present invention. One use of the data is to detect predicted behaviors in order to generate predicted events. This allows the system to learn certain operational patterns over time and automatically apply the predicted events in the future. Another use of the data is to monitor and compare the energy usage of the home to the energy usage prior to implementation of the home automation system. As such, the user can continually monitor their energy consumption savings on a regular basis.

These and other advantages will become apparent from a reading of the following summary of the invention and description of the illustrated embodiments in accordance with the principles of the present invention.

### BRIEF DESCRIPTION OF THE DRAWINGS

The foregoing summary, as well as the following detailed description of the illustrated embodiments is better understood when read in conjunction with the appended drawings. For the purpose of illustrating the invention, there is shown in the drawings embodiments that illustrate what is currently considered to be the best mode for carrying out the invention, it being understood, however, that the invention is not limited to the specific methods and instruments disclosed.

FIG. 1 is a schematic diagram of an automation system in accordance with the principles of the present invention.

FIG. 2 is a schematic diagram of a first menu system for a user interface in accordance with the principles of the present invention.

FIG. 3 is a schematic diagram of a second menu system for a user interface in accordance with the principles of the present invention.

FIG. 4 is a schematic diagram of a method for modifying a first set of system parameters in accordance with the principles of the present invention.

FIG. 5 is a schematic diagram of a method for modifying second set of system parameters in accordance with the principles of the present invention.

FIG. 6 is a schematic diagram of a method for modifying third set of system parameters in accordance with the principles of the present invention.

FIG. 7 is a schematic diagram of a method for modifying fourth set of system parameters in accordance with the principles of the present invention.

FIG. 8 is a schematic diagram of a method for modifying fifth set of system parameters in accordance with the principles of the present invention.

FIG. 9 is a schematic diagram of a master database of the system in accordance with the principles of the present invention.

FIG. 10 is a schematic diagram of a software polling protocol in accordance with the principles of the present invention.

FIG. 11 is a schematic diagram of a method for programming a macro in accordance with the principles of the present invention.

FIG. 12 is a is a schematic diagram of a method for programming a scheduled or timed event in accordance with the principles of the present invention.

FIG. 13 is a is a schematic diagram of a method for initiating a macro in accordance with the principles of the present invention.

FIG. 14 is a schematic diagram of a system for controlling a hybrid power controller in accordance with the principles of the present invention.

FIG. 15 is a schematic diagram of software for operating a hybrid power controller in accordance with the principles of the present invention.

FIG. 16 is a schematic diagram of a method for setting up energy control parameters of the system in accordance with the principles of the present invention.

FIGS. 17A and 17B are front views of a user interface in accordance with the principles of the present invention.

FIG. 18 is a schematic diagram of a system for controlling utility consumption of a facility in accordance with the principles of the present invention.

FIG. 19. is a schematic diagram of a method for controlling utility consumption of a facility in accordance with the principles of the present invention.

### DETAILED DESCRIPTION OF THE ILLUSTRATED EMBODIMENTS

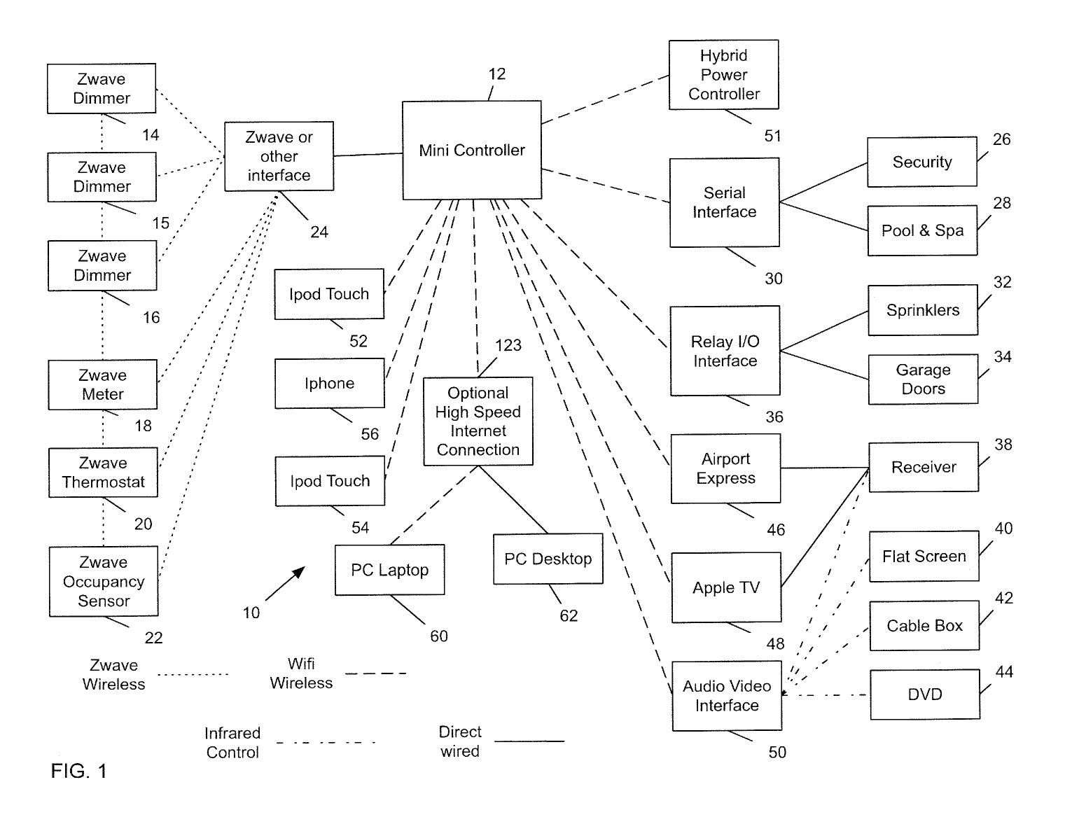

Referring to the drawings, FIG. 1 is a schematic diagram of a home automation system, generally indicated at 10, in accordance with the principles of the present invention. In the embodiment of the home automation system 10, a controller 12, in the form of a MAC MINI, is employed to operate and control the system 10. Of course, other PCs and PC operating systems may be employed, such a Windows-based PC or Linux-based PC. The controller 12 uses software (as will be described in more detail) to control the various system components. Communications between the controller 12 and the various system components may be wireless (e.g., Z-wave, WI-FI, infrared, RF etc.) or by hard wiring. The system may be in communication with various Z-wave components, such as dimmers 14, 15 and 16, meter 18, thermostat 20 and occupancy 22. The controller 12 uses a Z-wave interface 24 to enable two-way communication between the Z-wave components and the controller 12.

Other components and component interfaces may also be controlled with the controller 12. For example, serial-based components, such as security alarms 26 and pool and spa equipment 28, may be coupled to a serial interface 30 that is in communication with the controller 12. Likewise, various other systems, such as sprinkling system controllers 32 and garage door openers 34 may be controlled by a relay I/O interface 36. Audio/Video equipment, such as A/V receivers 38, televisions 40, cable television set-top boxes 42 and DVD players 44 may be controlled by the controller 12 by employing one or more interface devices, such as an Airport Express component 46, APPLE TV system 48 or other Audio/Video interface 50. Finally, a power controller 51 may be operated and controlled by the controller 12 to allow the system to integrate electricity producing components, such as solar panels, windmills, watermills and the like, into the system. Thus, the system will not only monitor and reduce energy consumption of the home or building to which the system 10 has been installed, but integrate power sources into the system, and when energy consumption allows, feed unused energy back into the electrical grid.

The controller 12 may be accessed, monitored and remotely controlled by one or more user interfaces. For example, one or more IPOD TOUCH devices 52 and 54 and/or IPHONE 56 may be used as a remote device to monitor, display and control controller 12 functions. Also, by connecting the controller to a modem 58, such as a DSL or cable modem, a PC laptop 60 or PC desktop computer can be remotely used to access the controller 12 via the Internet to display and control the functions of the controller 12. The webpage for the controller is generated within the controller and accessed via the controller's IP address via the laptop, or desktop, and also via the IPHONE 56 via the Internet. This also will allow a third party to remotely service the controller or any of the connected system components if needed.

Accordingly, the basic system employs the use of a controller 12, which by way of example may be in the form of a Mac Mini or other personal computer. A user interface to operate and monitor the controller may an IPOD TOUCH or IPHONE, which allows the user to interface with, access and control the system 10. Also, an auxiliary or alternative interface may comprise any web browser software on any personal computer, laptop, tablet PC or PDA that can access the controller 12 via the Internet or similarly the local area network. The system 10 may also include a WI-FI relay and input interface. This allows control of sprinkling systems, garage door openers, fountains, fireplaces, gates and other devices and systems. Also, WI-FI or other forms of wireless communication with various metering devices can be employed to monitor energy consumption by wirelessly linking with natural gas, propane and/or electrical meters. In addition, WI-FI enabled appliances may be linked to the system 10 to allow direct or indirect control and operation of ovens, refrigerators, dish washers, washers and dryers and water heaters, among others. It is anticipated that while existing standards for interface of appliances may initially be utilized, the system 10 may be updated to accept and communicate with any new and/or reduced complexity standards. In addition, the system of the present invention may be configured to accept other alternative common interfaces that may be implemented by standards groups and/or appliance manufacturers.

A WI-FI serial interface may be employed to provide a communications link and thus integrate the controller with security systems, lighting systems, climate control systems, pool and spa systems, appliances, and power and other utility meters (either whole house/facility and/or individual circuit or appliance metering) among others. Likewise, a Z-wave interface may link the controller to Z-wave lighting systems, climate control systems, utility meters (e.g., water, gas and electricity meters), occupancy sensors, window treatments, etc. A WI-FI infrared interface may be employed to link the system to AV systems, to learn new infrared control codes and to add to the library of control codes. The user can add new AV equipment by simply pointing the new remote at the AV controller and learning the new infrared codes.

Accordingly, the system 10 of the present invention can help reduce energy consumption by controlling usage of lighting, climate, water and gas or propane. In the case of a system that also integrates power generation (e.g., solar, wind or water power generation), the system can feed excess energy back to the grid. The system 10 of the present invention is simple for the end user to install and operate and easily control such systems as AV systems or motorized systems such as blinds, garage door openers and the like. In addition, because all of the systems are controlled from a single controller 12, the system is configured to integrate and share data between the various components in order to decrease energy and/or water consumption. For example, data from the security system can be used to control lighting and climate by detecting room occupancy. Likewise, data from weather information can be used to change watering amounts and/or times of the sprinkling system. Rate information from various utility meters can be used to change light dimmer levels and temperature set points of the climate control system as well as inhibit appliances from operating during transient or pre-arranged peak cost periods as determined by the utility provider. The graphical user interface of the system 10, whether on a monitor connected to the controller 12 or via a remote user interface, such as an IPHONE, provides a status page that shows up-to-date energy usage, approximate energy bills, weather information, security status, the status of any house-wide scenes that may be in effect and the like. The system 10 of the present invention is configured to self discover the addition of new equipment. Accordingly, a user need only purchase the additional equipment and activate the new equipment within the range of the controller 12 (or one of the components of the system that can operate as a repeater). The controller 12 will automatically detect any new components that have been activated and that are within range, prompting the user to identify the component and to add the new component to the system 10.

The system 10 can be remotely operated from away from the home or building within which the system 10 has been installed. The controller 12 can be accessed via the Internet by logging into their home from any computer that has Internet access. Once logged into the controller 12, the user has complete control of the system 10 as if operating the system from home. Thus, the user can, for example, set the system 10 into a “vacation mode,” set schedules and limits on lighting levels, temperature set points and operation time limits of certain equipment, such as televisions. Because APPLE products have proven to be reliable, easy to use and incorporate a reliable system and protocol for auto-detection of external components (both wired and wireless), the present system 10 according to the present invention is made even more user friendly, thus increasing the potential for integration of the system 10 into the common household, Other systems currently available use MICROSOFT WINDOWS operating systems. The Windows operating system, including Windows Vista, has proven to be unstable and unreliable. In addition, the use of APPLE products significantly lowers the expense of such a system. For example, using a Mac Mini as the controller 12 and an IPOD TOUCH as the user interface currently costs approximately $900. Conversely, a competing product, such as a CRESTRON Pro2 processor and CRESTRON touch panel, will cost the user approximately $5600.

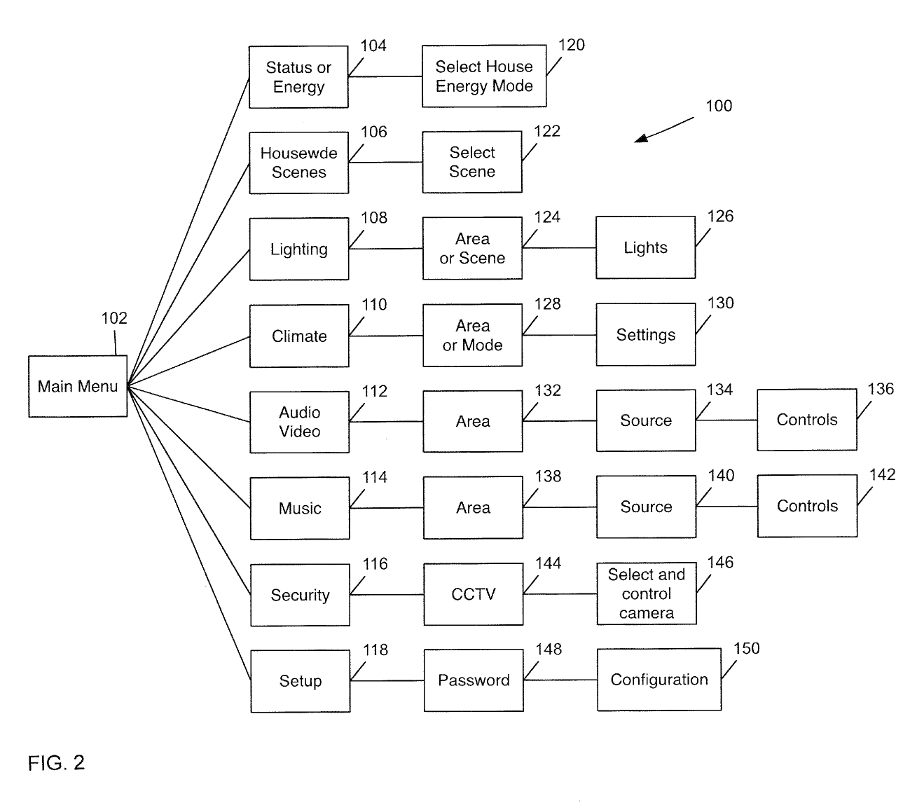

Referring now to FIG. 2, there is illustrated a schematic diagram of a software program 100 according to the principles of the present invention. The software 100 is configured to provide a main menu 102 on a monitor, such as an LCD screen, displaying graphical user interface. The main menu 102 provides on the display a list of user selectable icons or buttons. Each icon or button provides access to a submenu of controls for a particular subsystem connected to the controller (previously described) of the system. Thus, individual icons or buttons are provided for Status or Energy 104, Housewide Scenes 106, Lighting 108, Climate 110, Audio Video 112, Music 114, Security 116 and Setup 118. Of course, other icons for other systems or appliances may also be added. When selecting the Status or Energy icon 104, the software 100 provides the user with various options to Select the House Energy Mode 120. This may include entering a “Vacation” mode in which the climate, lighting and other systems are set to reduce energy consumption while making the home appear occupied by employing various lighting schemes. Likewise, the system may enter an occupied mode in which the climate and lighting are controlled based upon occupancy detection within a particular room or rooms. Other modes may include an “At Work” in which the system is reduces energy consumption by temporarily shutting down climate control systems until a particular time or temperature is exceeded.

When selecting the Housewide Scenes icon 106, the user can Select a Scene 122. For example, the lighting could be modified to set a particular scene, such as “Open House,” in which all lights are increased to maximum luminescence in all rooms, “Romantic”, in which all lights are dimmed to a particular level, or “Occupied”, in which lights are turned on in rooms in which the security system or other motion detectors sense the presence of an occupant and lights are turned off in rooms where no occupancy is detected. In addition, the lighting may be controlled according to data received from a light sensor such that the light in a room is maintained at a certain luminance value, as opposed to a more standard practice of light level, to auto light leveling throughout the day. Thus, the system takes into account the difference between a light setting a power level and the indirect nature of setting a luminance value, which also includes in a more complex calculation to include the value of ambient light separate and apart from the light source that is being controlled by the system. When the lighting icon 108 is selected, the user can select and area or scene 124 from a list in order to control the lights in a particular area or from a particular scene. From there, the user can select specific lights 126 to control, or rooms to set a desired luminance value directly, by scene, or by house mode.

When the user selects the climate icon 110, the various areas or modes 128 relating to climate control are displayed. Once a particular area or mode is selected the settings 130 for climate in the particular area or mode are displayed and can be changed.

Selecting the audio video icon 112 first displays a list of Areas 132 in which audio or video equipment may be present. Once a particular area is selected, the various audio or video Sources 134 are displayed. When the user selects a particular source, the Controls 136 for that source are displayed.

Selecting the Music icon 114 operates similarly to the Audio Video icon 112. Thus, the software 100 will display a list of Areas 138 in which audio equipment may be present. Once a particular area is selected, the various audio Sources 140 for that area are displayed. When the user selects a particular source, the Controls 142 for that source are displayed.

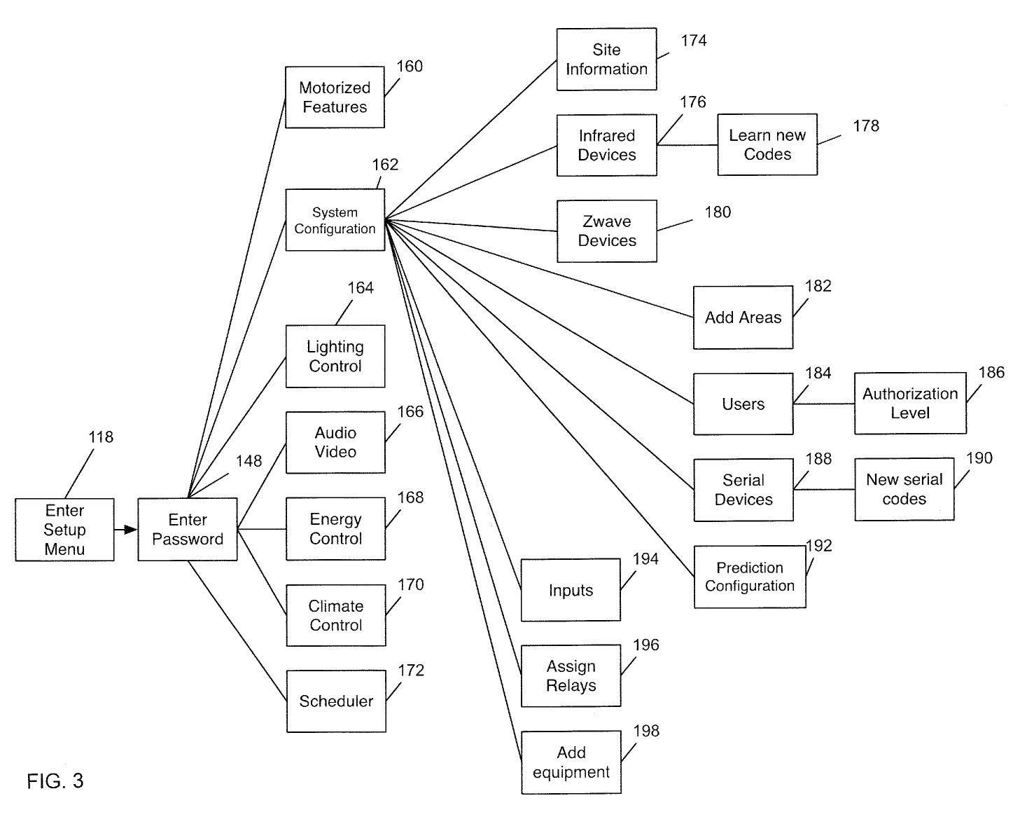

Selecting the Security icon 116 allows the user to select and view as a CCTV 144 (closed circuit television) any camera on the security system. Once selected, the user can Select and Control 146 and thus view any camera connected to the security system. If the configuration or parameters of the system need to be changed, the user can select the Setup icon 118. Once selected, the user will be prompted for a Password 148 so as to prevent unwanted modification to the system setup or parameters. Once the correct password has been entered, the system Configuration menu 150 is displayed to allow the user to make any desired modifications. Of course, other forms of user authorization may be employed, such as fingerprint or iris recognition, voice analysis & recognition, or forms of RF identification such as a typical key fob used in many office security systems. As shown in FIG. 3, once the user enters the setup menu 118 and enters the correct password 148, the various subsystems that can be controlled are displayed. The subsystems include motorized features 160, system configuration 162, lighting control 164, audio video 166, energy control 168, climate control 170 and scheduler 172, for example. Once a particular subsystem is selected the user can set the parameters of each subsystem as desired. For example, for motorized features 160, such as motorized blinds, the user could set the time of day when the blinds are raised, opened, lowered or closed.

Once the system configuration icon 162 is selected, the user can set up the system and parameters for the system itself and all system components. This may include site information 174, the number and location of infrared devices 176 (for which new codes can be learned 178), the number, type and location of all z-wave devices 180, add new areas 182 to the system, add new users 184 to the system including setting their authorization level 186 to limit access and control of the system by certain users, the type and location of all serial devices 188 (including adding new serial codes 190), setting the prediction configuration 192 parameters, adding, modifying or removing other inputs 194, assigning relays 196 or adding any other equipment 198 to the system.

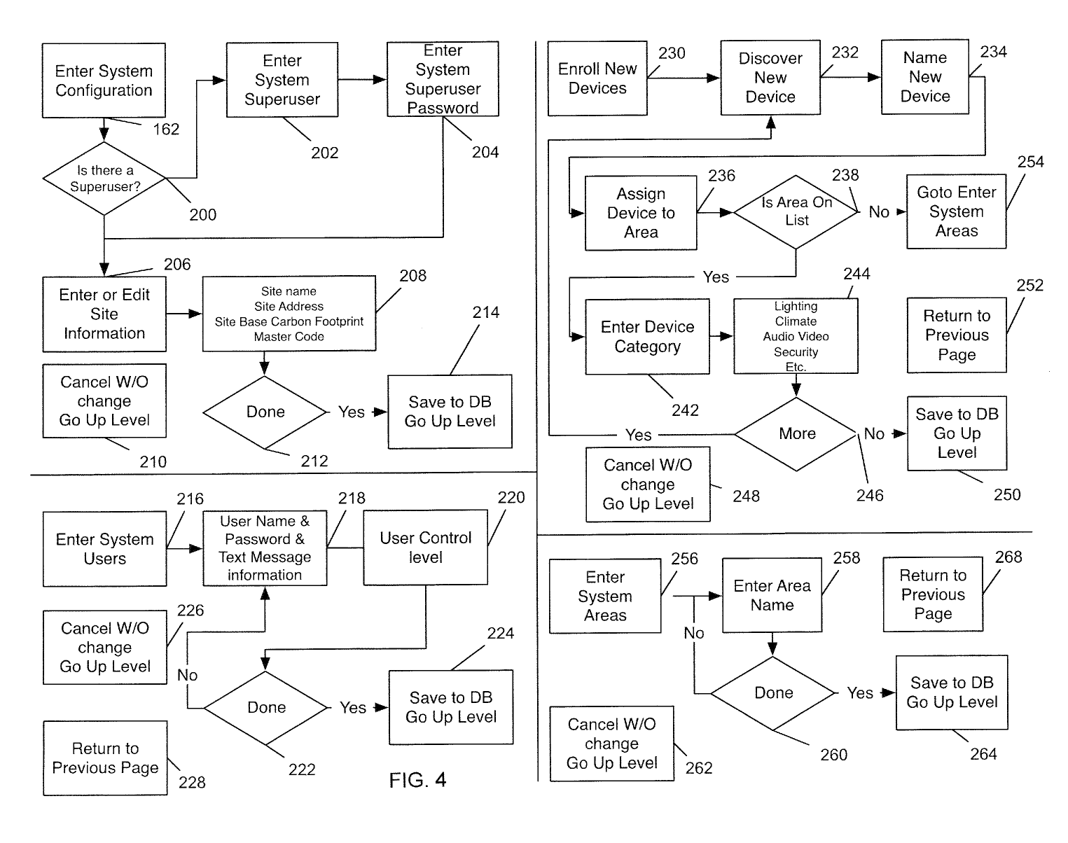

FIG. 4 illustrates various protocols set forth by the software according to the present invention when the user enters the system configuration 162. The software first inquires whether 200 there is a “superuser”. The superuser is essentially a top level administrator of the system that has access and control to all system parameters, set up features, password information, etc. If so, the superuser will enter their username 202 and password 204. The software is configured to allow a superuser. The superuser (typically the person that initially sets up the system), will have a password that allows all changes to the system and its configuration. The password for the superuser will be used to encrypt the database on the controller and will be needed to download a replacement copy of the database should the home controller become damaged or corrupted. The database on the controller will be automatically updated any time a change is made to the programming or when a configuration change is confirmed and saved.

The superuser can then select from various options. One option is to enter or edit site information 206 which includes various items 208 such as site name, site address, site base carbon footprint and master code. If the superuser makes a change they can either cancel 210 without change and the software will go back up one level or accept the change 212 in which case the software will save the new information to a database and go back up one level.

Another option is to enter system users 216. For each new user, the name, password and text message information is entered 218. Also, the user control level 220 is set. Once completed 222, the information is saved 224 to the database. If the operation is canceled 226, the system returns 228 to the previous page.

Yet another option is to enroll new devices 230. By employing auto-detection of devices, the system will discover 232 any new device. By way of example only, discovery may be fully automated (plug in, and it is recognized, appearing on a list), or manually triggered (a push of physical button or touch sensitive selection initiates a discovery operation). As new technologies become available for discovery, their use will not depart from the spirit and scope of this present invention. Once discovered, the user can name 234 the device and assign 236 the device to an area. If the area is on the area list 238, the user can enter 240 the device category 242 from the list 244. If more 246 devices need to be added, the process is repeated. If the changes are cancelled 248 the system will return to the previous level. If the changes are accepted, the changes are saved 250 to the database and the software returns to the previous page 252. If an area is not on the list 238, the software will direct 254 the user to the procedure for entering new system areas 256. The user can then enter 258 the area name and repeat this process for multiple areas. Once the user is done 260, the user can cancel 262 without saving any changes and going back one level 262 or accept the changes and save 264 the changes to the software database, at which time the software will return 268 to the previous page. The procedure for removing existing devices would operate similarly by allowing the superuser to select a particular device from the list of devices and remove the device from the list.

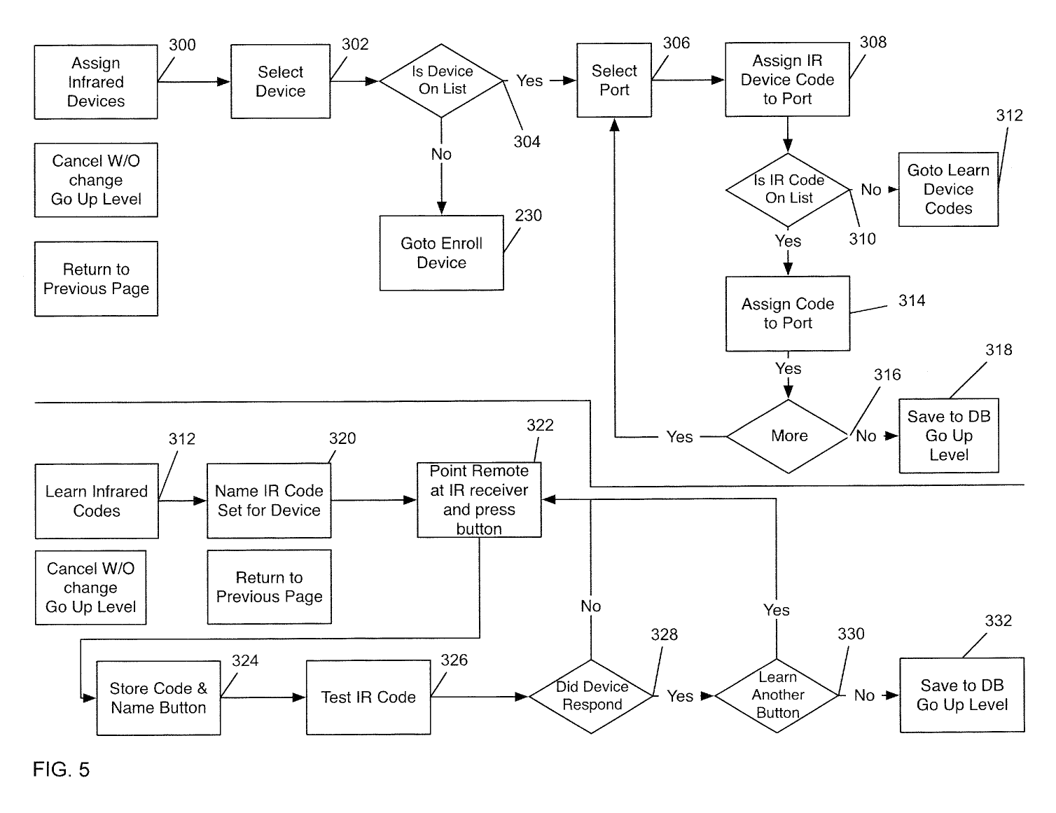

Another operation that can be performed in the system configuration mode is to assign infrared devices 300 as illustrated in FIG. 5. To assign the infrared device, a list of devices is displayed to allow selection 302 by the superuser. If the device is not on the list 304, the system returns to the enroll new devices protocol 230 illustrated in FIG. 4. If the device is listed, the user can then select 306 the port and assign 308 the IR device code to the port. If the IR code is not listed 310, then the user is taken to the learn infrared codes protocol 312. If the IR code is listed 310, the code is assigned 314 to the port. If more 316 codes need to be assigned, the process is repeated. If not, the software saves 318 the port assignments and codes to the database and returns to the previous menu level.

As further illustrated in FIG. 5, in order to learn 312 the IR codes, the user will name 320 the IR code set for the device. The user then points 322 the remote at the IR receiver and presses a button. The code is then stored 324 and the button is named. The IR code is then tested 326. By testing each IR code after learning, the system ensures that each code has been properly programmed and that each IR code works as expected. Conversely, prior art IR learning programs learn all of the IR codes and then the system is tested, often resulting in many IR codes that do not properly function. If the device responds 328 properly, the system moves 330 to the next button to be learned. If not, the learn operation for that button is repeated. Once all of the buttons have been learned, the user can chose to save 332 the learned IR codes to the database.

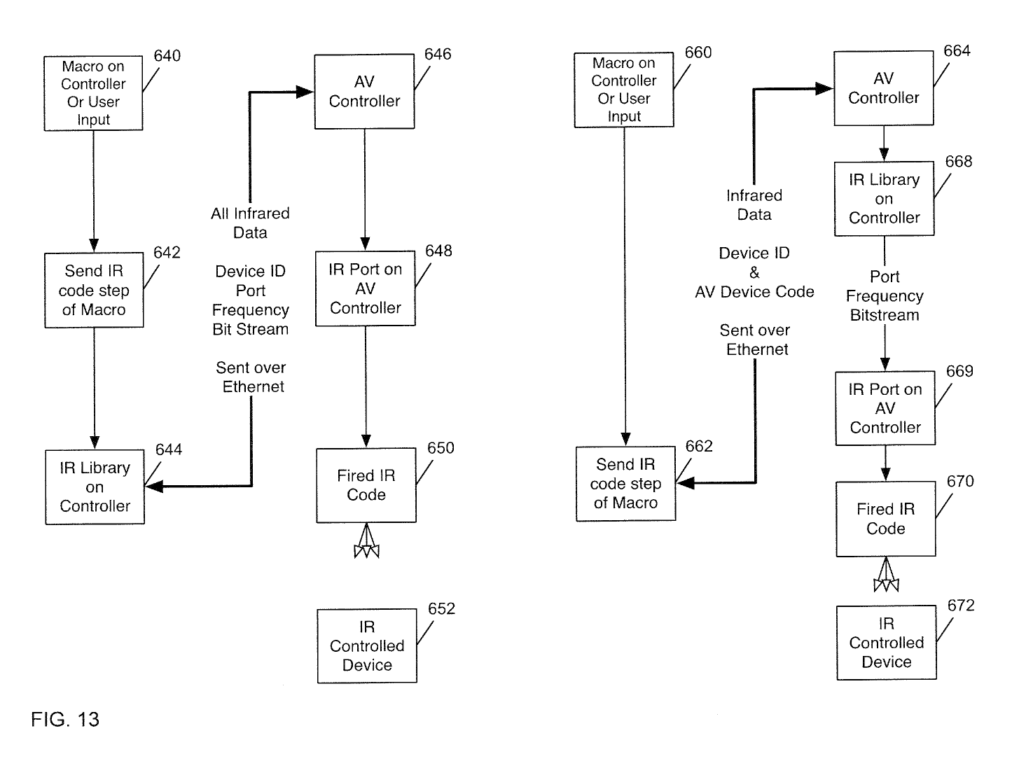

As shown in FIG. 13, the IR data may be onboard the main controller or onboard an AV controller. In the case where the IR data is onboard the main controller, a macro on the controller or user input is initiated 640. The controller then sends 642 the IR code step of the macro. The IR library on the controller is accessed 644 and the IR data is sent 646 to the AV controller. The IR port on the AV controller is activated 648 and the IR code is fired 650 to the IR controlled device 652. In the case where the IR data is onboard the AV controller, a macro on the controller or user input is initiated 640. The controller then sends 662 the IR code step of the macro. The macro is received by the AV controller 664, the IR library on the AV controller is accessed 668 and the IR port on the AV controller is activated 669 and the IR code is fired 670 to the IR controlled device 672. For those skilled in the relevant art, a reasonable progression of technology would afford an alternate embodiment including another form of wireless control from user input 640, to controlled device 652, such as RF wireless that is found currently in computer networks following Wi-Fi, or 802.11 standards. By way of example only, this description utilizes IR control that is most typically used in control of devices 652.

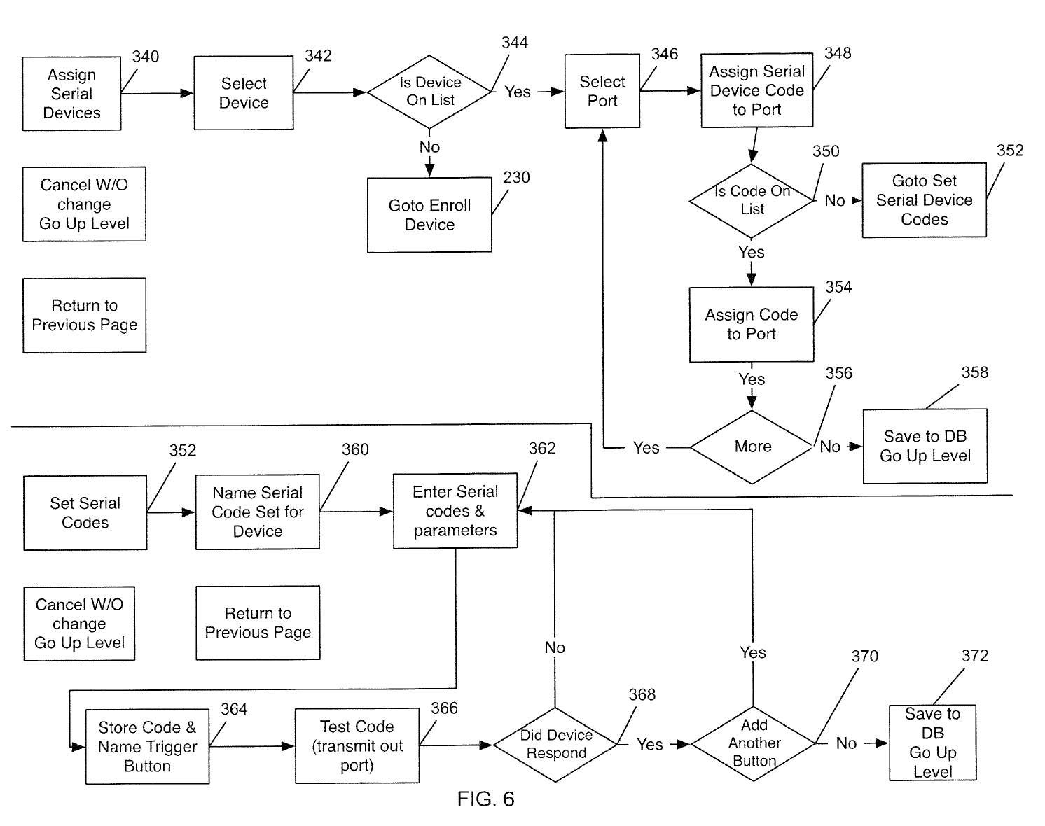

Referring now to FIG. 6, another process that can be selected by the superuser in the system configuration mode is to assign 340 serial devices to the system. Similar in operation to the assignment of IR devices, the software provides a list of devices that is displayed to allow selection 342 by the superuser. If the device is not on the list 344, the system returns to the enroll new devices protocol 230 illustrated in FIG. 4. If the device is listed, the user can then select 346 the port and assign 348 the serial device code to the port. If the serial code is not listed 350, then the user is taken to the learn serial codes protocol 352. If the serial code is listed 350, the code is assigned 354 to the port. If more 356 codes need to be assigned, the process is repeated. If not, the software saves 358 the port assignments and codes to the database and returns to the previous menu level.

As further illustrated in FIG. 6, in order to learn 352 the serial codes, the user will name 360 the serial code set for the device. The user then enters 362 the serial codes and parameters. The code is then stored 364 and the trigger button is named. The serial code is then tested 366 by transmitting out of the port. By testing each serial code after learning, the system ensures that each code has been properly programmed and that each serial code works as expected. Conversely, prior art serial learning programs learn all of the serial codes and then the system is tested, often resulting in many serial codes that do not properly function. If the device responds 368 properly, another button can be added 370 to the system by repeating the same operation. Once all of the serial codes have been learned, the user can chose to save 372 the learned serial codes to the database.

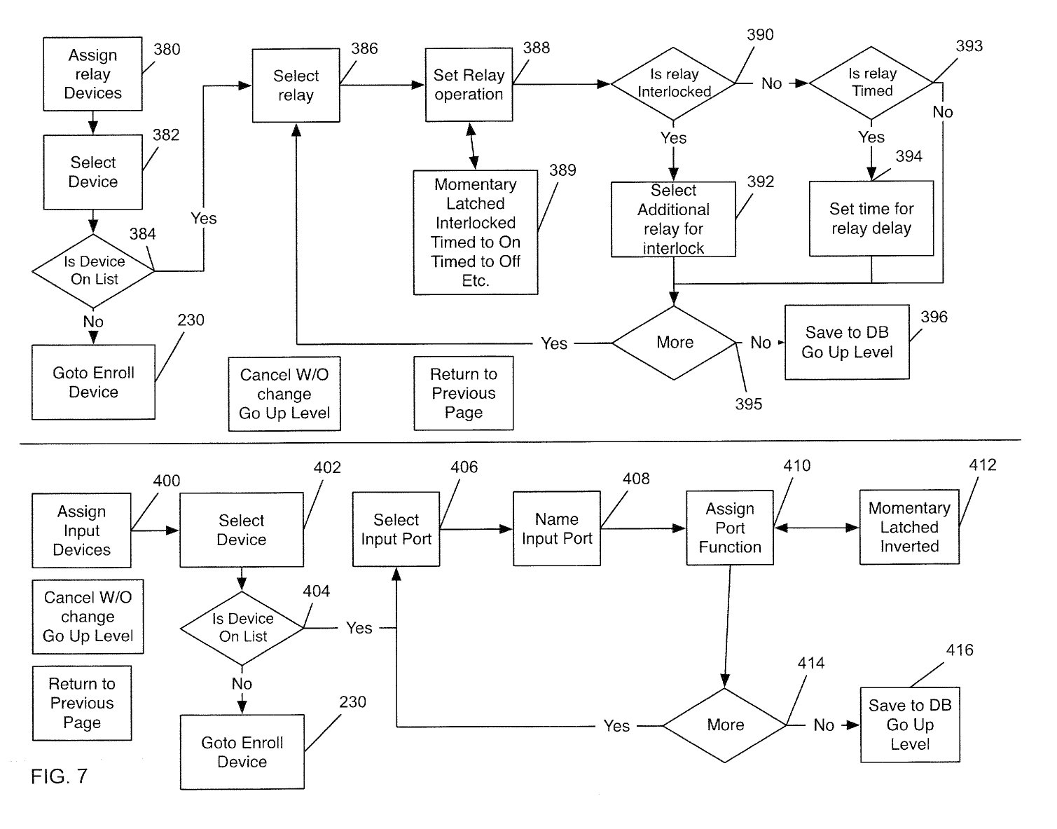

Relay devices can be assigned 380 in a similar manner as illustrated in FIG. 7. Similar in operation to the assignment of IR devices and serial devices, the software provides a list of devices that is displayed to allow selection 382 by the superuser. If the device is not on the list 384, the system returns to the enroll new devices protocol 230 illustrated in FIG. 4. If the device is listed, the user can then select 386 the relay to be assigned and set 388 the relay operation. For example, the relay operation can be set to various modes 389 such as momentary, latched, interlocked, timed to on, timed to off, etc. serial device code to the port. If the relay is interlocked, 390, an additional relay for interlock can be selected 392. If not, the software queries 393 whether the relay is timed. If the relay is timed, the time for the relay delay can be set 394. If more devices are to be added 395, the process is repeated. If not, the relay devices and settings are saved 396 to the system database.

To assign input devices 400, a protocol similar to the assignment of relay devices is followed. As illustrated in FIG. 7, the software provides a list of devices that is displayed to allow selection 402 by the superuser. If the device is not on the list 404, the system returns to the enroll new devices protocol 230 illustrated in FIG. 4. If the device is listed, the user can then select 406 the input port, name 408 the input port and assign 410 the port function. For example, the port function can be set to various modes 412 such as momentary, latched or inverted. If more devices are to be added 414, the process is repeated. If not, the input devices, input ports port names and port functions are saved 416 to the system database.

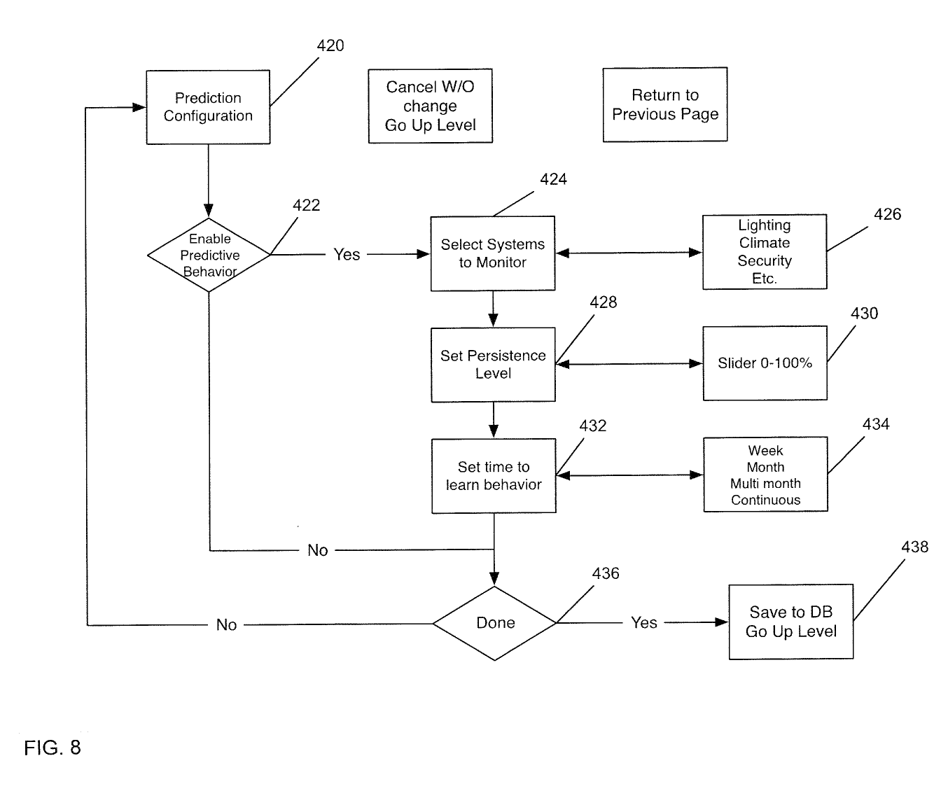

An important feature of the software system of the present invention is the ability of the system to develop its own set of parameters based upon predicted behavior(s). As shown in FIG. 8, the user can enter the prediction configuration 420 and enable 422 the predictive behavior feature of the software. Predictive behaviors can be created from any of the subsystems connected to the system controller. The user, however, can select 424 which system to monitor for predictive behavior. For example, the user can select from the subsystem list 426, which may include lighting, climate, security, etc. Once a particular subsystem has been selected 424, a persistence level is set 428. The persistence level may include a slider 430 that can range from 0% to 100%, where 0% represents system behaviors that occur rarely and 100% indicates behaviors that occur on a regular basis. The time to learn the behavior is also set 432. For example, the time may be selected from a list 434 that includes for a week, a month, multiple months, continuous, etc. Once the parameters for determining predictive behavior have been set and the user is finished 436, the setting can be saved 438 to the system database and the program return to the previous level.

There are four main types of events in the system, including an input event, an output event, a predicted event and a scheduled or timed event. Input events are triggers to any user function or macro from any of the possible inputs to the system. Such input events could be a sensor input, a utility rate change, a touch panel button press, a change in the status of the security system, a change in the level of solar panel output, etc. An output event is a trigger to perform a system action such as starting a lighting or AV macro, a climate setting change, printing data to a touch panel, etc. A predictive event is one that is learned by the system. That is, the system will watch when certain functions or macros are selected by the user and the time and conditions when that happens. The system will then learn to do perform the functions or macros for the user without user input. The system will send a message, e.g., a text message, to the user so that the user will know that the system is about to change its current mode of operation based upon a predictive event. This will provide the user with notification that the system is about to act on its own and allow the user to override the predictive event by accessing the controller directly or remotely.

The system is configured to allow the user to override any predictive event by simply selecting another operating mode or macro. For example, if the system learns that the house is always unoccupied Monday through Friday from 8 a.m. to 5 p.m., the system will automatically go into minimum energy usage mode by itself on those days and times. Since the system has learned at that point that at 5 p.m., the user will return home, the system will bring the house to normal mode prior to that time so that the house is back to its normal mode of operation when the user arrives. In the event that any motion detectors associated with the system or the security system indicates that a person is at home or has returned early, the system will automatically and immediately return the system to its normal “occupied” mode of operation.

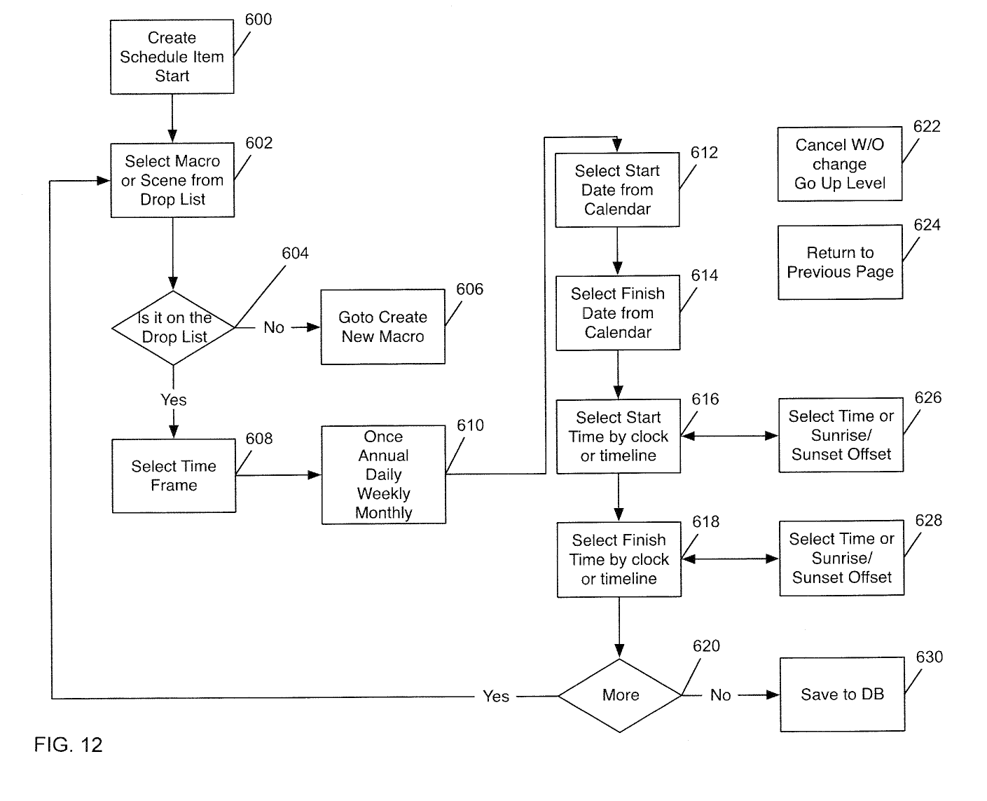

As shown in FIG. 12, the user can create 600 a scheduled or timed event. First, the user selects 602 a macro or scene from a list. If 604 the macro or scene is on the drop list the user selects 608 a time frame. If not, the user will create 606 a new macro. The time frame is then selected from the list 610, which may include once, annual, daily, weekly, monthly, etc. The user then selects 612 the start date, selects 614 the finish date, selects 616 the start time (and can select 626 the time or sunrise/sunset offset), selects 618 the finish time (and can select 628 the time or sunrise/sunset offset). If more 620 scheduled items are desired, the process is repeated. If not, the event is saved 630 to the system database.

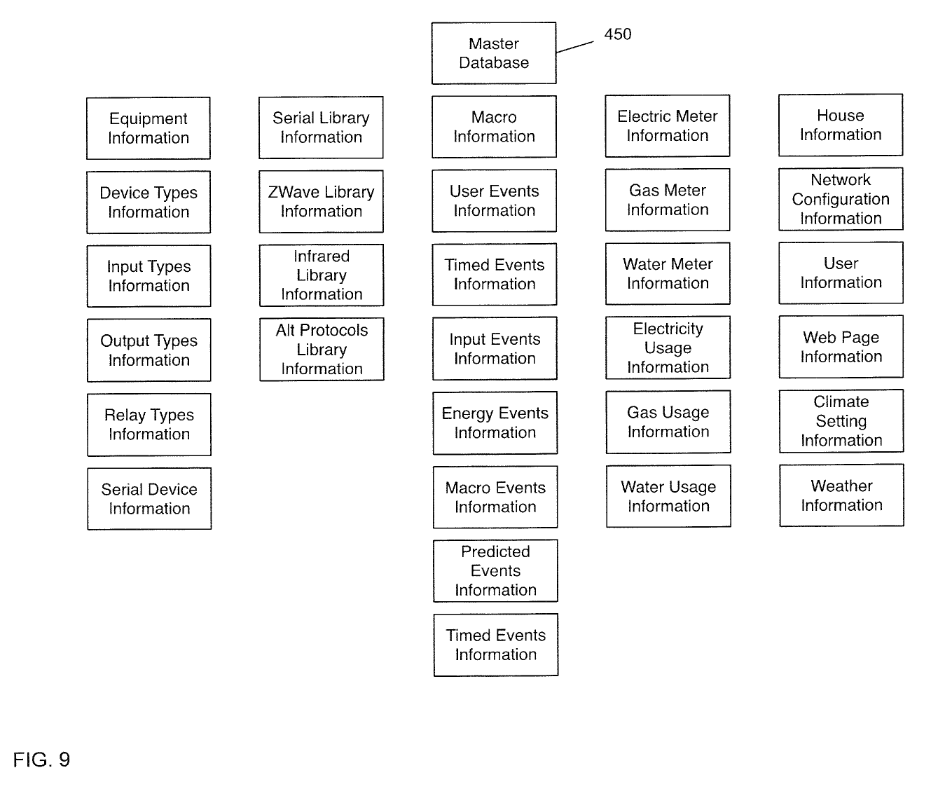

As illustrated in FIG. 9, the master database contains all of the equipment information, component information, system settings and other data controlled or used by the system. In one embodiment, the database 450 is stored on the hard drive of the system controller. In alternate embodiments, the database 450 may be also stored off-site through electronic transmissions, such as the internet, by a third party company that may have installed the system In yet another embodiment, the database 450 may be stored on an external storage device such as an external hard drive or flash thumb drive. That way, if the controller malfunctions or becomes inoperable, a new controller can be installed and the database reloaded onto the new controller so that the controller does not need to be reprogrammed once the system software has been installed and the database file uploaded. Thus, according to the present invention, data is backed up in at least three places. The database is stored in a backup file on the controller hard drive. The database is also stored on an optional USB device (e.g., a thumb drive) connected to the controller and stored via the Internet on the company servers that is responsible for installing and/or maintaining the system. In order to ensure secure communications, a particular embodiment of the invention will secure all communication between the controller and any third party monitoring service by following a rule that all communications be initiated from the controller to the company servers. The database will be backed up to the company servers and other backup points each night, along with energy credits earned for the prior twenty four hours. Also, any newly created infrared code information will be backed up to the company services. This allows the company to quickly develop an infrared code library for future use. A subscription service may be offered to maintain the database and automatically update any software updates to the controller.

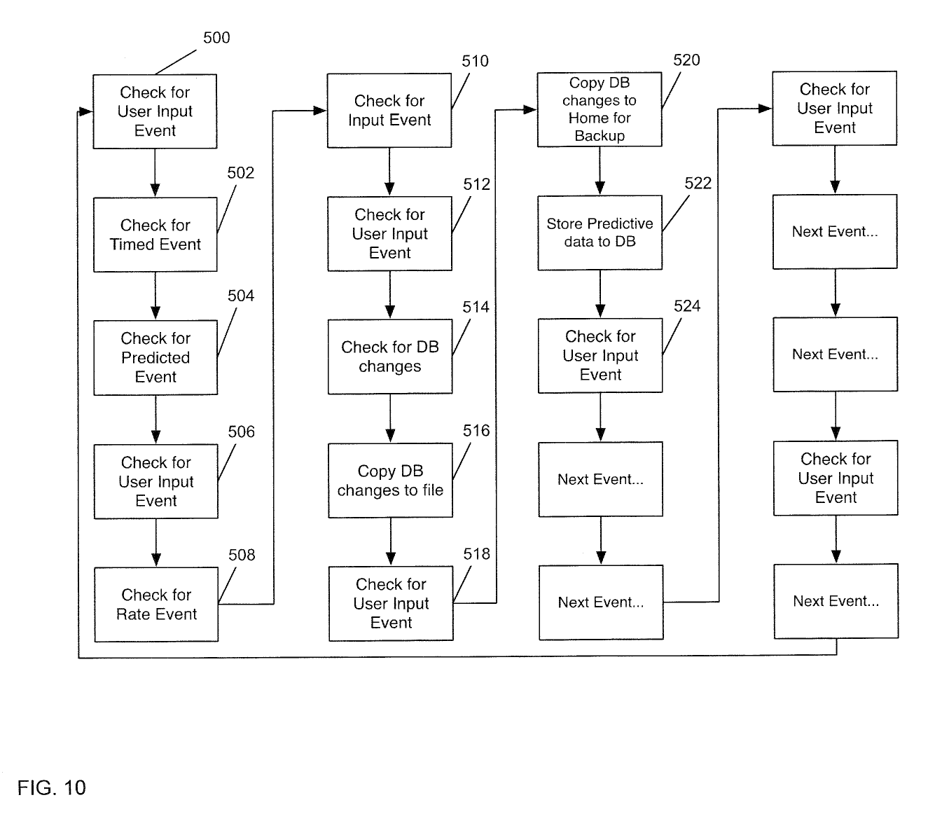

Another important feature of the software is the software polling protocol illustrated in FIG. 10. In order to ensure that any user input is responded to by the system in a rapid manner, the software regularly and continuously checks 500 for a user input event. That is, in addition to checking for other events, the software repeatedly checks for a user input to make sure that it does not delay responding to a user input while it is engaged in other monitoring activities. Thus, for example, the software will check 502 for a timed event, check 504 for a predicted event and then check again for a user input event 506. The software will then check 508 for a rate event, check 510 for an input event and then check 512 again for a user input event.

In the case where multiple steps are required to complete an operation, such as when making changes to the system database, the system will check 514 for any database changes and copy 516 the database changes to the database file. The process is then momentarily interrupted to check 518 for another user input event. The software will then return to copy 520 the database changes to the home system for backup and store 522 any predictive data to the database. The software will then again check 524 for a user input event. This process can be repeated for other events that may be set up on the system and is continuously repeated whenever the system is in operation. Thus, the software will always poll for any user interface between the steps of reading system data and doing system work so as to be responsive to user inputs.

The software is also programmable to some extent by the user through the use of macros. A macro comprises any user defined action or event that combines any number of steps and delay between steps that can be programmed into the system. The steps can be performed on any output or function of the system. For example, macros can be programmed for lighting dimmer levels, relay settings, infrared commands and temperature settings. As such, the system can be programmed to perform a number of steps or functions in sequence and in a time based manner as programmed by the user.

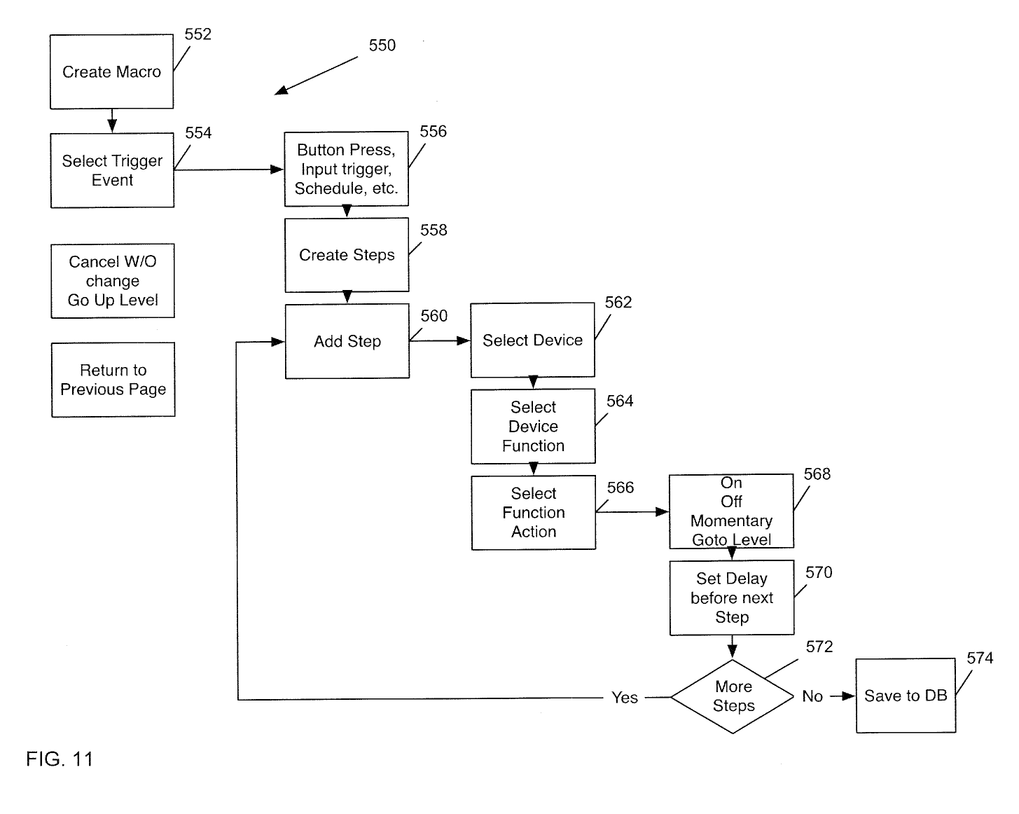

As shown in FIG. 11, the process 550 steps for programming or creating 552 a macro is illustrated. To begin, the user will select 554 a “Trigger Event” that will activate the particular macro. For example, the trigger event may comprise a button press, an input trigger, a scheduled event, or even an event triggered by a utility meter, such as a real-time change of rate and/or cost, as shown in list 556. The user then creates 558 the steps that will comprise the macro. Thus, the user will add 560 a new step, select 562 a device to be controlled during the step, select 564 the device function to be changed, select 566 the function action (e.g., on, off, momentary, goto level, etc.) as shown in list 568, set 570 the delay before performing the next step, chose 572 to add more steps or save 574 to the database when all of the desired steps have been included in the macro. As the steps are created, the software will display each step in sequential order along with any delay between steps so that the user can ensure that the macro is programmed correctly. The software will allow the user to drag and drop each created step to enable easy reordering of the steps. Once a step has been created, the user can double click on the step to change the step or delay.

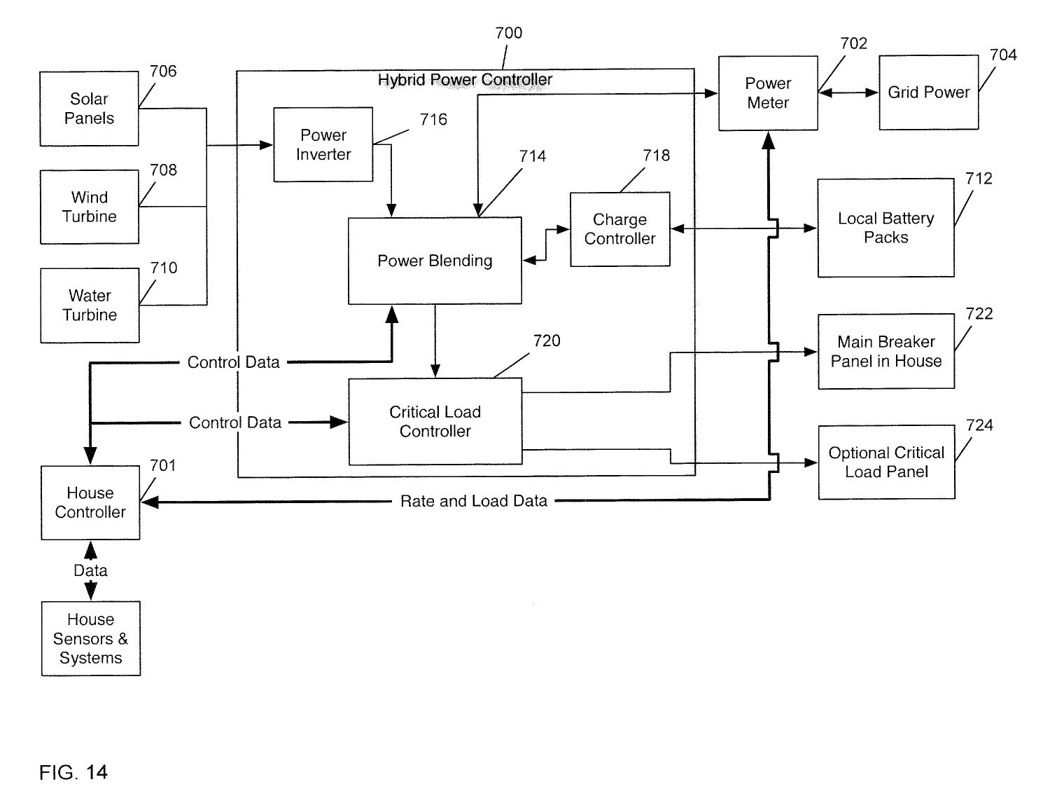

As shown in FIG. 14, the controller 701 of the present invention is configured to interact with, monitor and control a hybrid power controller 700. The controller 701 can be used to monitor energy usage and pricing from the meters 702 on the house. It will also know the time of day and get occupancy information from the security system and any occupancy sensors located in the building. The controller also gets information from the hybrid power controller 700 which monitors and controls the power load on the home and available power from the grid 704 as well as green power sources such as solar panels 706, wind turbines 708, water turbines 710, and other potential sources of power generation co-located with the residence. The power sources can optionally store their power on battery packs 712, or other storage sources known in the art. Using this information, the controller 701 will alter lighting levels and climate settings, raise and lower shades to increase or lessen solar gain (based on the season), and seamlessly blend the power from the various power sources to lower the power requirements from the grid. In addition, the system will calculate the carbon footprint savings compared to the baseline carbon footprint data in the system at the time of initial setup of the system. The initial carbon footprint may also be certified by Energy Star or an equivalent organization to ensure the accuracy of the initial value.

The hybrid power controller is comprised of a power blending component 714 that can is coupled to all of the power sources and can blend power from the various sources based on the power demands of the home. Thus, for example, if the home can be operated solely from the solar panels 706, the power blending component 714 will store power generated from the wind and water turbines until the battery packs 712 are full and then feed the balance to the grid 704. Likewise, if the power requirements of the home exceed that coming from the green power sources, the power blending component 714 will allow power from the grid 704 to enter the system to supplement the power requirements and blend power from the grid with power from the green power sources. A power inverter 716 is used to convert the power from the green power source to an AC current and phase usable by the power blending component 714. A charge controller 718 is coupled between the power blending component 714 to allow power from the power blending component to charge the battery packs 712 and for converting power from the battery packs back to an AC voltage and phase for use in the home.

The power controller 700 also includes a critical load controller 720 that couples the power blending component 714 to the main breaker panel 722. An optional critical load panel 724 may also be employed.

The house controller 701 is in communication with the power meters 702 as well as the power blending component and the critical load controller. As such, data is received from the power blending component so that the controller 701 knows how much power is being used from each source. The controller also sends control data to the power blending component to control the amount of power used from each source based on system needs derived from data received from the power meter (e.g., rate and load data) as well as from the critical load controller. As such, the controller 701 both controls internal power consumption based on usage requirements of the home as well as various power source availability in order to lower energy consumption and to maximize use of green energy sources as much as possible.

Thus, in periods where the house demands are very low, such as during the late night when only critical systems (e.g., refrigeration, climate, etc.) and night lighting may be on, the hybrid power controller may run the house only off the battery packs 712. During periods when the solar panels are generating more energy that the house needs, the hybrid power controller will be directed to shunt any excess power into the grid 704 to help lower the home's energy bills and help the local utility carry commercial loads. During power outages, the house controller 701 will go into a critical power mode and shut down unnecessary systems, dial others back and feed critical loads from the battery packs 721. The house controller, 701, may also be aware of utility rate/cost and real time rate/cost changes either indirectly through power meter (or other utility meter) 702, which is connected to its respective utility company, or directly to the utility company via the internet (shown in FIG. 1; not shown in FIG. 14 for simplicity).

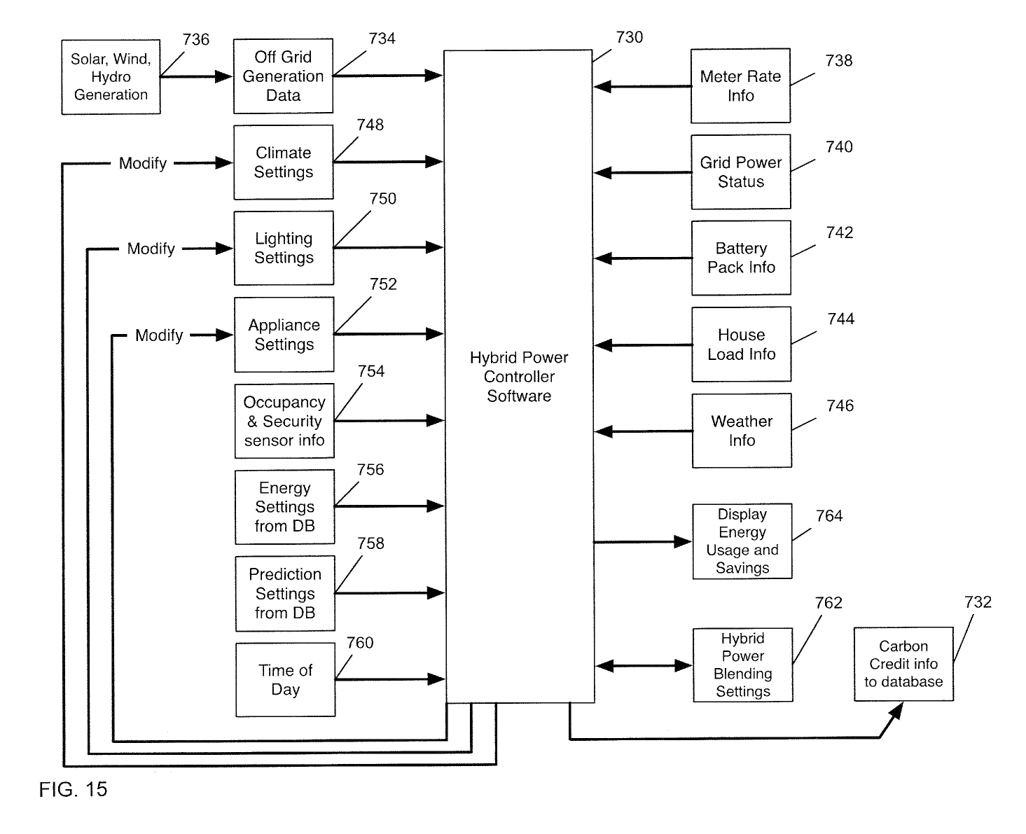

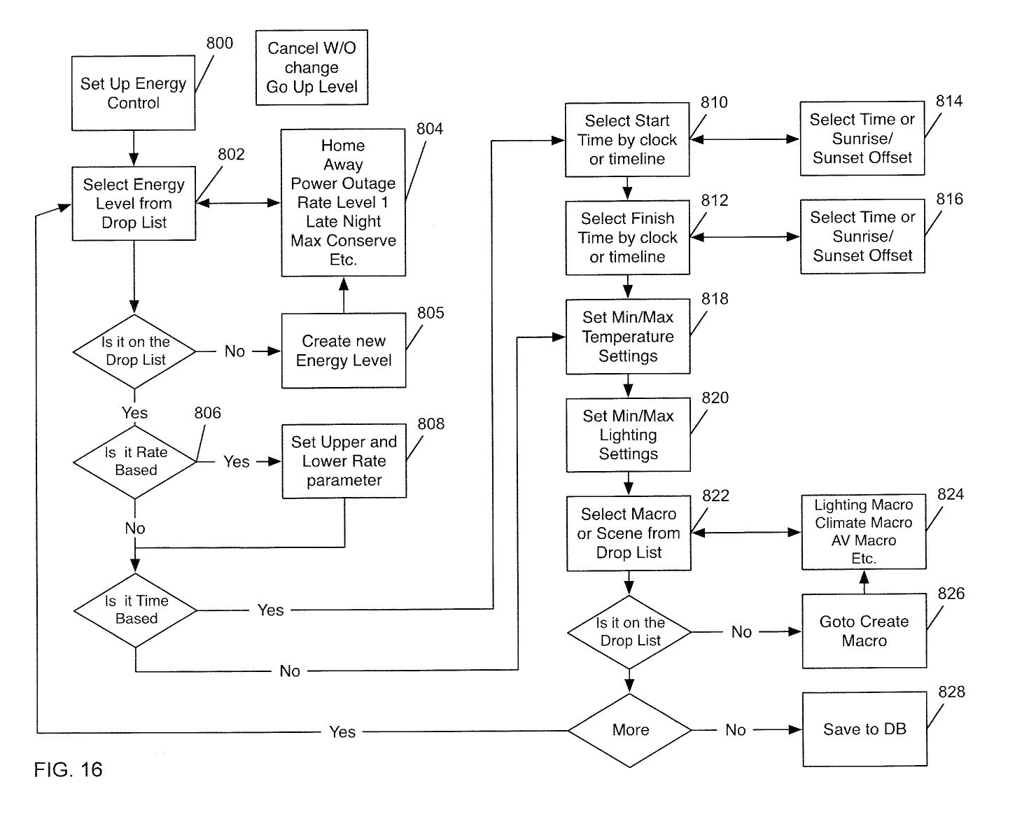

As shown in FIG. 15, the hybrid power controller 700 is provided with its own software 730 that can calculate and report 732 Carbon Credits to the database of the house controller. The software 730 receives off grid power generation data 734 as a result of solar, wind, hydro or other green power generation 736, meter rate and other utility info 738, grid power status 740, battery pack or other power storage capacity info 742, house load info 744 and weather info 746. The software also receives data regarding climate settings 748, lighting and/or luminance settings 750, appliance settings 752, occupancy and security sensor info 754, energy settings 756 from the database, prediction settings 758 from the database and time of day 760. All of this information allows the software to set the power blending settings 762 as needed from the various sources in the most energy efficient manner and to modify climate, lighting and appliance settings if needed. The software can also display 764 the energy usage and energy savings. In order to set up the user's preferences regarding energy usage and control behaviors of the system, the user can name various energy “scenes” (i.e., create various energy consumption schemes) and set various parameters that the system will operate within to minimize energy usage through control of power generation sources, power storage sources, controlled systems and appliances, and maximize energy return to the grid, as possible within the set parameters. As shown in FIG. 16, in order to set up energy control parameters of the system 800, the user will select 802 the energy level from the list 804. For example, Home, Away, Power Outage, Rate Level 1, Late Night, Max Conserve, etc. If the desired energy level is on the list 804, the software will inquire 806 whether the energy level is rate based. If the energy level is not on the list, the software will allow creation 805 of a new energy level. If the energy level is rate based, the user can set 808 the upper and lower rate parameters. If the energy level is time based, the user can select 810 and 812 the start and stop times and/or select the time or time offsets 814 and 816. If not, the user will go directly to setting 818 the min/max temperature settings, setting the min/max lighting settings 820, select 822 any macros or scenes from the list 824, create 826 any new macros as needed and save 828 the settings to the database when finished. As such, the user has complete control over the energy usage settings, can customize the settings for various use modes and allow the system to conserve as much energy as possible based on these parameters.

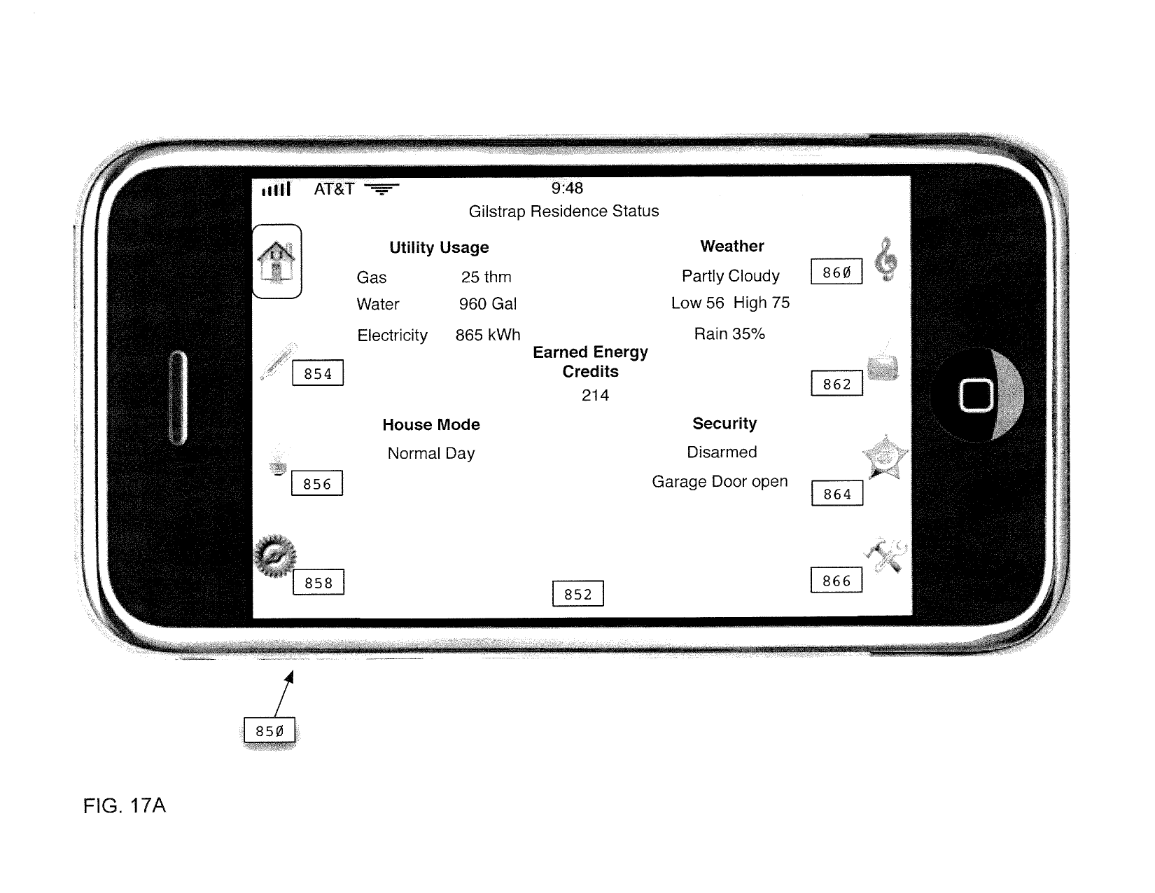

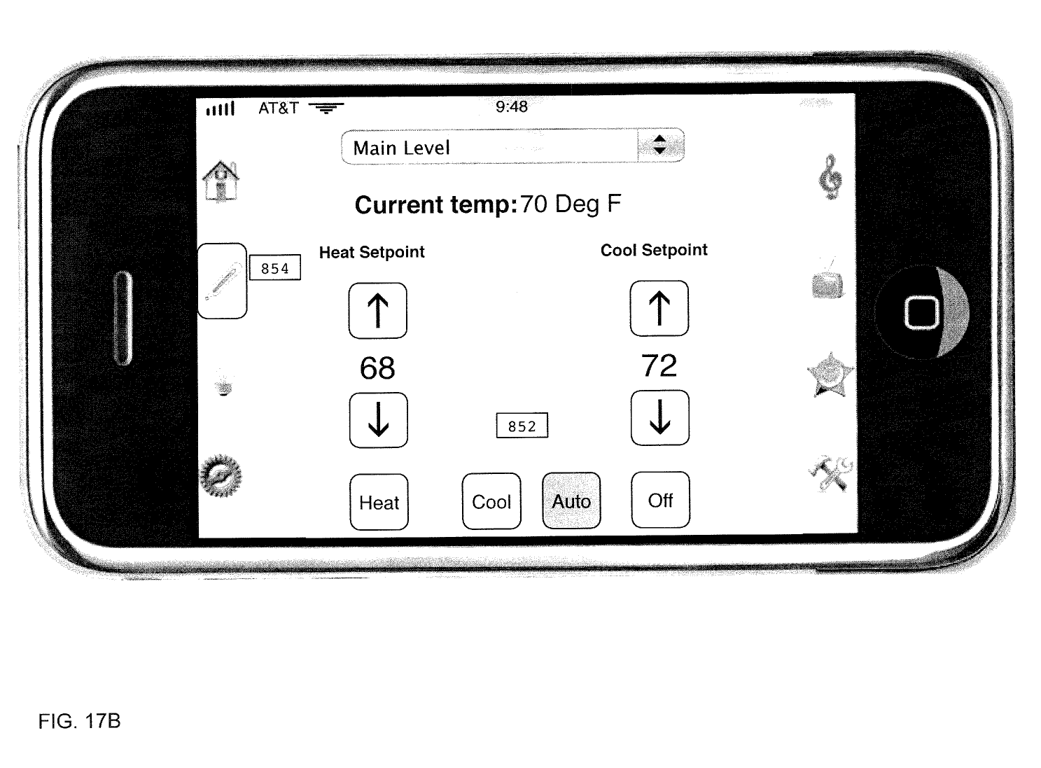

As shown in FIG. 17A, a user interface 850 comprises an APPLE IPHONE. The interface 850 is in communication with the system controller and displays various system information for the user. In the home mode as illustrated, the interface 850 displays the Utility Usage, including energy credits earned, the House Mode, the Weather and the Security status. The icons surrounding the perimeter of the display 852 represent the various subsystems being controlled by the home controller that can be accessed and controlled via the user interface 850. Thus, by touching the thermometer icon 854, the user can view and change any of the climate settings. By touching the light bulb icon 856 the user can view and change one of the lighting settings. Motorized controls can be accessed via the gear icon 858, audio systems via the clef icon 860, AV equipment via the television icon 862, security via the badge icon 864 and system settings via the hammer and wrench icon 866. Of course, other icons may be employed to control other corresponding subsystems.

As shown in FIG. 17B, when the user selects the thermometer icon, the display provides various icons for controlling the thermostat of the climate control system of the home, similar to the controls found directly on the thermostat. Thus, the user can change the heat or cool set points, turn the system on or off or change the mode of operation. Because of the built in zoom function of the IPHONE, a touch of one button, for example when trying to access a function from an AV remote control, results in a “zoom in” function to provide all of the multiple user buttons associated with that function. When the operation is completed, the user can then zoom back out to a higher menu level.

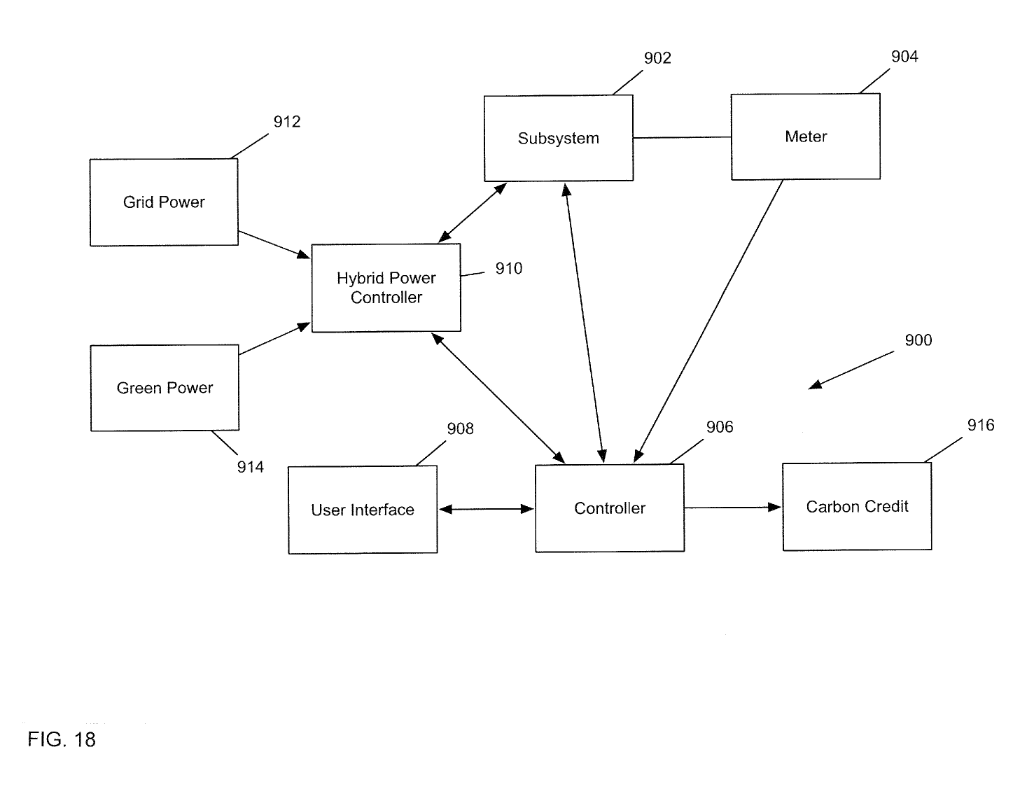

Referring now to FIG. 18, a system, generally indicated at 900, is configured for monitoring and controlling utility consumption of at least one subsystem of a facility. The system 900 includes a subsystem 902 capable of being remotely controlled. An energy or utility meter 904 is coupled to the subsystem and is capable of monitoring energy or utility consumption of the subsystem and providing data corresponding to the monitored energy or energy consumption to a controller 906. The controller 906 is in communication with the subsystem 902 and the meter 904 and is configured to control the operation of the subsystem based upon a subsystem operation protocol. The subsystem operation protocol is dependent at least in part on the data received from the meter 904. The various arrows set forth in FIG. 18 represent the various communication pathways between the various system components. Such communication pathways may be in the form of direct wiring, wireless communications (e.g., Wi-Fi, cellular, etc.) or local area network, internet-based or other forms of communication known in the art.

A user interfaces with the controller 906 through a user interface 908, the user interface 908 is configured to allow a user to monitor and control the operation of the subsystem 902 to selectively modify and control the subsystem operation protocol.

The facility may comprises a residence, in which case, the subsystem 904 may comprises at least one of a heating system, a cooling system, lighting, a water heater, an oven, a refrigerator, a dish washer, a clothes washer and a clothes dryer. The subsystem operation protocol is dependent at least in part upon utility rate information in order to limit operation of the subsystem 902 during peak rate periods. The controller 906 is configured to collect data regarding the status and operating parameters of the subsystem 902 when operated by the user to detect at least one behavior of the user and to modify the subsystem operation protocol based on the at least one behavior. The modification of the subsystem operation protocol is based in part on a timed event at which time the controller causes a change in state of the operation of the at least one subsystem.

The system 900 also includes a hybrid power controller 910 configured for monitoring and controlling a power load on the facility and for blending power from a grid power source 912 and a green power source 914 to meet the power needs of the facility while minimizing power from the grid power source 912. The controller 906 alters an operational parameter of the subsystem 902 of the facility in order to lower power requirements from the grid power source 912.

The controller 906 is capable of determining a carbon footprint savings by comparing a certified baseline carbon footprint of the facility prior to installation of the system and a post-installation carbon footprint in which the system is in operation. The controller then generates a carbon credit 916 based upon the carbon footprint savings.

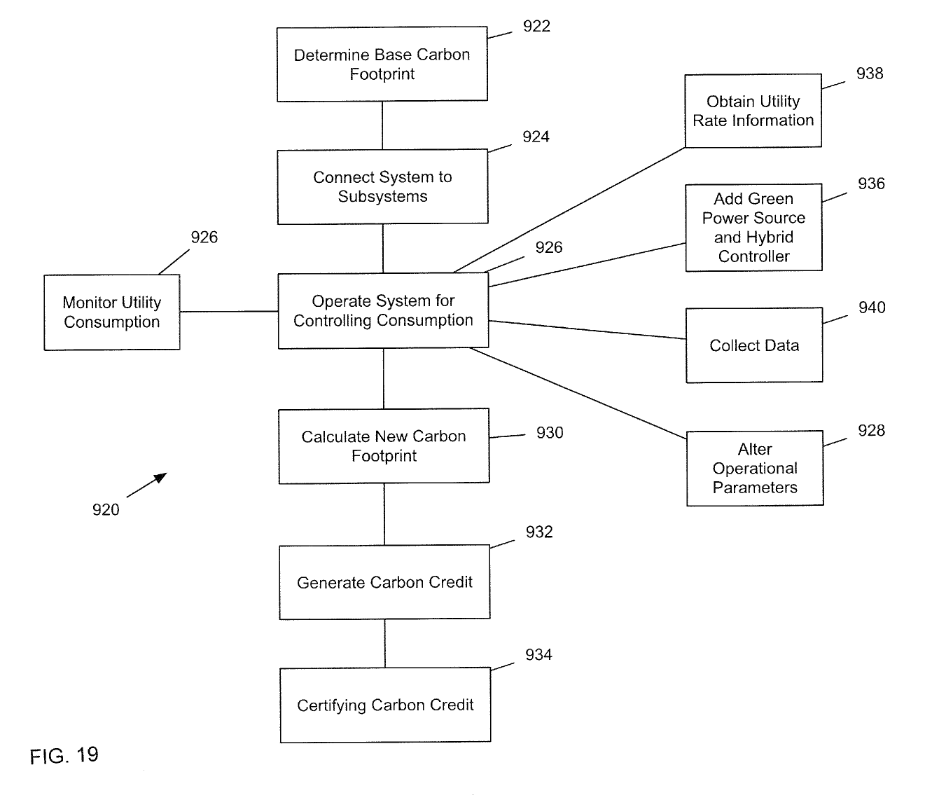

Referring now to FIG. 19, there is illustrated a method of generating carbon credits, generally indicated at 920, in accordance with the principles of the present invention. The method 920 includes the steps of determining 922 a base carbon footprint of a facility. To determine the base carbon footprint, the energy and/or other utility usage of the facility is determined and the resulting carbon footprint calculated. Such a base carbon footprint may be certified by an independent agency or entity, such as ENERGY STAR. A system for controlling and monitoring utility consumption is connected 924 to the facility, and more specifically to one or more subsystems of the facility that use a utility in its operation. The system is operated 926 to monitor 926 and control utility consumption of the facility by altering 928 operational parameters of the subsystem. The system comprises monitoring equipment for receiving utility usage data and controlling equipment for automatically controlling utility consumption of the facility based on a consumption profile. The utility consumption is monitored 926 in real time so as to provide time accurate data based on actual utility usage. The system then calculates 930 a new carbon footprint based on the actual utility consumption. Based on the difference between the base carbon footprint and the new carbon footprint, the system generates 930 a carbon credit. The carbon credit is then certified to create a tradable commodity.

The method 920 may include and accommodate the adding 936 of a green power source and hybrid power controller. The hybrid power controller is configured for monitoring and controlling a power load on the facility and for blending power from a grid power source and a green power source to meet the power needs of the facility while minimizing power from the grid power source. In controlling utility consumption and/or decreasing usage from a grid power source, the system may alter 928 various operational parameters of the facility in order to lower utility consumption. This alteration 928 may also include the use of a subsystem-based operation protocol. The protocol is dependent at least in part upon obtaining 938 utility rate information in order to limit operation of a subsystem in communication with the system during peak rate periods. During its operation, the system, also collects 940 data regarding status and operating parameters of the subsystem when operated by the user to detect a repeated behavior of the user then modifies the subsystem-based operation protocol in order to repeat the repeated behavior. The subsystem-based operation protocol thus may be based at least in part on a timed event at which time the controller causes a change in state of the operation of the subsystem.

The system of the present invention provides many features and capabilities not presently offered by existing home automation systems. The home automation system of the present invention can be employed to monitor and control energy usage and hybrid power blending, lighting, climate controls, security systems, audio video equipment, music, CCTV, access control, motorized screens and shades, motorized skylights, appliances, garage doors, spa and pool controls, gates, sprinklers, irrigation systems, pet doors, etc. The system provides a multi-user, multi-tasking operating system, remote management and maintenance, self discovery of network devices, secure network control and communications, built in Ethernet, WI-FI, USB ports and Fire wire ports. The system also provides peer to peer networking ability, built in hard drive storage, a built in optical drive and DVI video out. The system can be controlled from Mac, Linux, or Windows based computers, laptops, tablets, and PDAs. The system can host, control and setup web pages. Also functions can be scheduled since the system has a built-in calendar and astrotime. The system also has weather station ability. The system can communication with multiple protocol devices, control of multiple protocol devices, learn infrared control codes, and can transmit infrared control codes, can communicate with wired devices using RS232, 485, CANBus, MODBus, etc. The system can handle wired or wireless communications, can use WI-FI, Ethernet, Zigbee, Zwave, mesh network communications, and 900 MHz, 2.4 & 5.8 GHz, etc. for communications and control. The system can be controlled with a touch panel, wall mounted keypad, handheld remote, or telephone control and may include voice recognition. The system can even rip, store, and stream music and video entertainment to multiple areas wirelessly or wired.

The system is extremely simple and has user friendly configuration and control software. The wireless touch panel has multi-touch interface and a zoomable interface.

The hybrid power controller of the present invention allows for solar, hydro or wind input, includes battery supply and backup, can monitor power flow to and from the house and the power grid, can modify the power usage of the house and appliances based on rate information and time of day from metering and provides seamless power blending. The hybrid power controller easily and seamlessly integrates with the home system controller.

While the presently described system has been disclosed as a “home” automation system, the present invention could be utilized in any facility, building structure or group of structures, including without limitation office buildings, apartment or condominium complexes, duplexes, plants and retail spaces. In addition, while the system of the present invention has been described in relation to “appliances” and/or “subsystems,” such terms are intended to include any device that consumes or uses a utility, whether the utility be in the form of electricity, natural gas, propane, water, oil, coal, or any other form of a consumable natural resource. Thus, while the methods and apparatus of the present invention have been described with reference to certain illustrative embodiments to show what is believed to be the best mode of the invention, it is contemplated that upon review of the present invention, those of skill in the art will appreciate that various modifications and combinations may be made to the present embodiments without departing from the spirit and scope of the invention as recited in the claims. Reference herein to specific details of the illustrated embodiments is by way of example and not by way of limitation.

What is claimed:

1. A system for monitoring and controlling utility consumption of at least one subsystem of a facility, comprising:
at least one subsystem capable of being remotely controlled;
an energy meter coupled to the at least one subsystem capable of monitoring energy consumption of the at least one subsystem and providing data corresponding to the monitored energy consumption;
a controller in communication with the at least one subsystem and the energy meter, said controller configured to control the operation of the at least one subsystem based upon a subsystem operation protocol, the subsystem operation protocol dependent at least in part on the data received from the energy meter;
a user interface in communication with the controller, the user interface configured to allow a user to monitor and control the operation of the at least one subsystem and to selectively modify the subsystem operation protocol.

2. The system of claim 1, wherein the facility comprises a residence and the at least one subsystem comprises at least one of a heating system, a cooling system, lighting, a water heater, an oven, a refrigerator, a dish washer, a clothes washer and a clothes dryer.

3. The system of claim 1, wherein the subsystem operation protocol is dependent at least in part upon utility rate information in order to limit operation of the at least one subsystem during peak rate periods.

4. The system of claim 1, wherein the controller is configured to collect data regarding the status and operating parameters of the at least one subsystem when operated by the user to detect at least one behavior of the user and to modify the subsystem operation protocol based on the at least one behavior.

5. The system of claim 4, wherein the modification of the subsystem operation protocol is based in part on a timed event at which time the controller causes a change in state of the operation of the at least one subsystem.

6. The system of claim 1, further comprising a hybrid power controller configured for monitoring and controlling a power load on the facility and for blending power from a grid power source and a green power source to meet the power needs of the facility while minimizing power from the grid power source.

7. The system of claim 1, wherein said controller is capable of determining a carbon footprint savings by comparing a certified baseline carbon footprint of the facility prior to installation of the system and a post-installation carbon footprint in which the system is in operation.

8. The system of claim 6, wherein the controller alters an operational parameter of a subsystem of the facility in order to lower power requirements from the grid power source.

9. The system of claim 7, wherein said controller is capable of generating carbon credits based upon the carbon footprint savings.

10. A method of generating carbon credits, comprising:
determining a base carbon footprint of a facility;
operating a system for monitoring and controlling utility consumption of the facility, the system comprising monitoring equipment for receiving utility usage data, controlling equipment for automatically controlling utility consumption of the facility based on a consumption profile;
monitoring actual utility consumption in real-time;
calculating a new carbon footprint based on the actual utility consumption;
generating at least one carbon credit resulting from a difference between the base carbon footprint and the new carbon footprint.

11. The method of claim 10, further comprising adding a green power source and hybrid power controller to the system, the hybrid power controller configured for monitoring and controlling a power load on the facility and for blending power from a grid power source and a green power source to meet the power needs of the facility while minimizing power from the grid power source.

12. The method of claim 10, further comprising altering an operational parameter of a subsystem of the facility in order to lower utility consumption.

13. The method of claim 10, further comprising providing a subsystem-based operation protocol, the protocol being dependent at least in part upon utility rate information in order to limit operation of at least one subsystem in communication with the system during a peak rate period.

14. The method of claim 10, further comprising collecting data regarding status and operating parameters of the at least one subsystem when operated by the user to detect at least one repeated behavior of the user and modifying a subsystem-based operation protocol based to repeat the at least one repeated behavior.

15. The method of claim 14, further comprising basing the subsystem-based operation protocol at least in part on a timed event at which time the controller causes a change in state of the operation of the at least one subsystem.

16. The method of claim 10, further comprising certifying the carbon credit.

17. A system for generating energy credits by monitoring and controlling energy consumption of at least one subsystem of a facility, comprising:
means for determining a base amount of energy units used by at least one subsystem;
means for measuring actual energy units used by a subsystem in real time;
means for controlling the at least one subsystem to reduce the amount of energy units used by the subsystem compared to the base amount;
means for calculating a difference between the base amount of energy units and the actual energy units; and
means for generating an energy credit based on the difference.

18. The system of claim 17, further comprising means for providing a user interface to allow a user to remotely set operational parameters of the at least one subsystem.

19. The system of claim 18, further comprising means for predicting a user behavior in order to automatically change operational parameters of the at least one subsystem.

20. The system of claim 17, further comprising means for blending a green power source and a grid power source in order to minimize usage of the grid power source by the at least one subsystem.
